(19) United States
(12) Patent Application Publication
(10) Pub. No.: US 2023/0116401 A1
(43) Pub. Date: Apr. 13, 2023

(54) SYSTEM AND METHOD FOR VALUATION AND COLLATERALIZATION OF ILLIQUID ASSETS IN A BLOCKCHAIN-BASED ECOSYSTEM

(71) Applicant: Suresh Nichani, Iselin, NJ (US)

(72) Inventor: Suresh Nichani, Iselin, NJ (US)

(21) Appl. No.: 17/964,757

(22) Filed: Oct. 12, 2022

Related U.S. Application Data
(60) Provisional application No. 63/254,611, filed on Oct. 12, 2021.

(51) Int. Cl. G06Q 40/06; G06Q 20/12; H04L 9/00; G06Q 40/04; G06Q 40/02

(52) U.S. Cl. CPC G06Q 40/06; G06Q 20/123; G06Q 40/04; G06Q 40/025; H04L 9/50

(57) ABSTRACT

Provided is a method and system for valuation and collateralization of illiquid assets in a Blockchain-based ecosystem. A price oracle system is implemented as a valuation, risk and DeFi layer that runs on top of a DeFi protocol. A live data feed engine interfaces with multiple real-world data sources to connect meaningful data to influence asset values and processes these into the correct format for a valuation engine. A valuation engine accesses real-time data feeds from the live data feed engine and a risk engine. The risk engine is a real-time risk matrix and analysis tool using machine learning algorithms that weigh a real asset and produce a risk-formatted readout for the valuation engine. The valuation engine works through real-time balancing of input and defines the price of an asset as output and communicates with a price oracle to produce real asset prices on the Blockchain.

### RELATED APPLICATION

This patent application claims the benefit of priority to U.S. Provisional Pat. Application No. 63/254,611 to Nichani, filed Oct. 12, 2021 and incorporated by reference herein in its entirety.

### FIELD

Various embodiments of the present disclosure generally relate to the valuation of real assets. Specifically, the present disclosure relates to a system and method for a price oracle for illiquid assets in a Blockchain-based ecosystem, which accesses and processes real-time data feeds to determine pricing or decipher the valuation of any real asset and collateralize any revenue-producing real assets.

### BACKGROUND

Traditional real asset or physical asset investing entails a multitude of issues. A key issue is the high transaction fees involved in any real asset (for example, real estate) deals, often including excessive charges for middleman fees. Another issue is the illiquid market, together with the liquidity conundrum. On top of fees, the long processing time experienced when dealing with all the intermediaries inevitably makes investing a tedious process, contributing to an illiquid market. Further, high transaction fees, including capital that is enough to sustain the long, drawn-out process of investing in assets traditionally, set up a perceptively higher barrier of entry because the market appears to be suitable only for high net-worth individuals capable of bearing extravagant costs, and requiring significant coordination from numerous parties.

Currently, liquidity in fractional ownership of real assets is typically non-existent. Traditionally, achieving secondary market liquidity is administratively cumbersome and expensive. Direct investors in properties or property owners cannot gain immediate liquidity on their ownership in the same way an equity, commodity, or cryptocurrency investor would accomplish the same.

The business of real assets is one of the oldest industries; sellers and buyers on both sides, and intermediaries, are only familiar with existing processes, which have had little change over the years. Despite introducing new processes built on top of cutting-edge technologies, existing platforms currently face initial liquidity issues, as education and marketing of disruptive technologies require time. As such, there needs to be a better system underpinning a liquidity engine than a traditional buyer/seller book model, which is common in most trading engines today.

Furthermore, extreme volatility does not work when involving real assets. Apart from liquidity, the volatile nature of trading engines due to shifting market sentiment and inefficiencies would result in extreme swings in prices, which is not typical for real asset investments, and may lead to deficiencies in pricing and unreflective of real-world value Short-term speculation does not fulfill objectives of building a sustainable economy. Therefore, the design and operation of secondary markets for an asset token platform must ensure that short-term volatility is curbed and that liquidity is efficiently managed in a way traditional systems do not provide.

Erstwhile applications of the Blockchain technology lack the disruptive factor in the financial markets because they cannot translate real-world assets directly onto the Blockchain. Best efforts have been for synthetic assets and major commodities such as gold or even stocks. Still, the existing technology does not tackle ownership due to a lack of ability to track and value the majority of underlying real assets.

Furthermore, existing oracle solutions for illiquid markets face several issues. The steps using existing oracle solutions are as follows: A contract saves the state of a current transaction to the contract’s storage. The contract then emits an event to request a data query and stops the current transaction. An off-chain network waits for enough transaction confirmations. The off-chain network invokes a callback transaction with the supplied query result. The contract then validates the transaction, recovers the state, and continues execution. These oracle solutions do not provide a holistic approach based on considering data from various sources and factors and hence cannot give an accurate valuation of illiquid assets in a real-time context.

Existing centralized data feeds cannot provide synchronous interactions and have a central point of failure. Existing data feeds of real assets are random and scattered. There is no trusted source of data that can be readily tapped on.

Existing Blockchain oracles are unable to aggregate and solve the aforesaid issues. Due to the centralized nature of such oracles, the data feed plugged in provides the oracles with absolute control and power on information served to smart contracts on various Blockchains. However, corrupted data would not be addressed or fixed downstream of the data pipeline in case of a critical failure at this point.

Furthermore, existing data provider networks suffer from asynchronous interactions between smart contracts and data layers. This method complicates smart contract implementations and introduces a significant delay as two Blockchain transactions need to be confirmed and executed sequentially.

Limitations and disadvantages of conventional approaches will become apparent to one of ordinary skill in the art through comparison of described systems with some aspects of the present disclosure, as outlined in the remainder of the present application and with reference to the drawings.

### SUMMARY

A system and method for determining the valuation of illiquid assets and collateralization of revenue-producing real assets in a Blockchain-based ecosystem is provided substantially as shown in and/or described in connection with, at least one of the figures as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates a system for the valuation and collateralization of one or more real assets in a Blockchain-based ecosystem in accordance with an exemplary embodiment of the disclosure.

FIG. 2 is a diagram that illustrates a price oracle infrastructure in accordance with an exemplary embodiment of the disclosure.

FIG. 3 is a diagram that illustrates a flowchart of a method for valuation and collateralization of one or more real assets in a Blockchain-based ecosystem in accordance with an exemplary embodiment of the disclosure.

### DETAILED DESCRIPTION

The following described implementations may be found in the disclosed system and method for a price oracle to determine pricing or valuation for illiquid assets in a Blockchain-based ecosystem and collateralize these assets. The system includes a live data feed engine configured to access live data feeds from one or more data sources. The live data feed engine receives consistent data feeds from the one or more data sources aggregated in an Interplanetary File System (IPFS). The live data feeds include a combination of data streams that may include, but are not limited to, price and asset inflation data, Consumer Price Index (CPI) and Non-CPI inflation data, Volatility Index (VIX) data, data relating to real estate leasing activity, data from commercial mortgage-backed securities (CMBS) data providers, data about collateralized debt obligations, sales data, occupancy data from real pages for real estate, hotel occupancy, and hotel sales data, market data on the hotel industry worldwide including supply and demand and market share data providing various valuation metrics, data related to Uniform Commercial Code (UCC) filings, Securities and Exchange Commission (SEC) filings, credit ratings, data related to markets, news, research, companies, and pricing on various real assets and commodities.

The system further includes a risk engine configured to derive risk assessment data based on analyzing the live data feeds.

The system further includes a valuation engine configured to decipher the valuation of one or more real assets based on the risk assessment data and the live data feeds. Upon determining that the valuation of a real asset falls below a predefined threshold or a low-water mark, the risk engine is configured to notify an asset owner for providing additional collateral against a loan, wherein the asset owner has collateralized the real asset and taken the loan from an exchange. The valuation engine is linked to an asset owner who has collateralized the real asset and taken a loan from an exchange. The exchange may include but is not limited to, a DeFi exchange and a Swap exchange.

The valuation engine is configured to continuously provide the latest valuations on collateralized debt to a price oracle based on one or more machine learning algorithms.

In accordance with an embodiment, the risk engine is configured to continuously assess risks produced by the live data feeds and updated valuations produced by the valuation engine from the live data feeds.

In accordance with another embodiment, the risk engine interfaces with one or more external entities. The one or more external entities may include, but are not limited to, insurance companies, a decentralized investment committee, custodians who hold liens, UCC filings, and documents.

In accordance with yet another embodiment, the risk engine comprises a real-time risk matrix and analysis tool comprising one or more machine learning algorithms. The one or more machine learning algorithms are adapted to weigh a real asset and produce a risk-formatted readout for the valuation engine.

In accordance with yet another embodiment, the risk engine is configured to reset one or more key indicators about additional collateral put up by an asset owner to abide by a contractual agreement. Upon determining that the additional collateral is not put up by the asset owner within a certain timeframe, the risk engine is configured to automatically produce one or more default tokens indicating that a borrower has defaulted or missed a loan covenant.

Upon determining that the asset owner does not put up the additional collateral in case of a valuation change, or the asset owner has defaulted on interest payments or has broken any covenants in a loan agreement with the valuation engine, the risk engine is configured to perform additional actions that may include, but are not limited to, producing default tokens, and liquidating original asset tokens.

In accordance with yet another embodiment, the risk engine is configured to transmit a signal to the valuation engine for potential re-evaluation of a real asset and associated tokens of the real asset upon perceiving a new risk or a substantial change in the valuation of the real asset.

The valuation engine is configured to receive as input the live data feeds from the live data feed engine and the risk assessment data from the risk engine. The valuation engine is configured to perform real-time balancing of the received input, define prices of the one or more real assets as output, and communicate with a DeFi protocol to produce the prices on the Blockchain system.

In accordance with an embodiment, the price oracle interfaces with an asset token exchange and is configured to feed asset token valuation to a real-time token pricing engine. The price oracle interfaces with the Swap exchange for DeFi components and liquidity pools for one or more collateralized debt obligations and synthetic tokens. The Swap exchange for collateralized debt and liquidity tokens, and the synthetic tokens, in turn, connect with an automated market maker (AMM). The AMM allows buyers and sellers to swap cryptocurrencies on an exchange, by using pre-funded on-chain liquidity pools.

The real-time token pricing engine is configured to aggregate prices for the one or more real assets if the one or more real assets are collateralized and provide a valuation of each of the one or more real assets. The one or more reals assets are split into a plurality of levels of tokens including, but not limited to, General Partner (GP) token, Liquidity Provider (LP) token, Debt Token, Mezzanine token, and Synthetic token.

In accordance with an embodiment, upon determining that an asset owner does not increase collateral to get a collateral value required above a high-water mark that has been set by the valuation engine, within a certain period, the risk engine is configured to automatically produce default tokens and send the default tokens to an auction engine for processing. The auction engine interfaces with an investor portal. As soon as the auction engine mints the default tokens, the system is configured to notify one or more investors via the investor portal and place the default tokens in an investment gallery for viewing and investments.

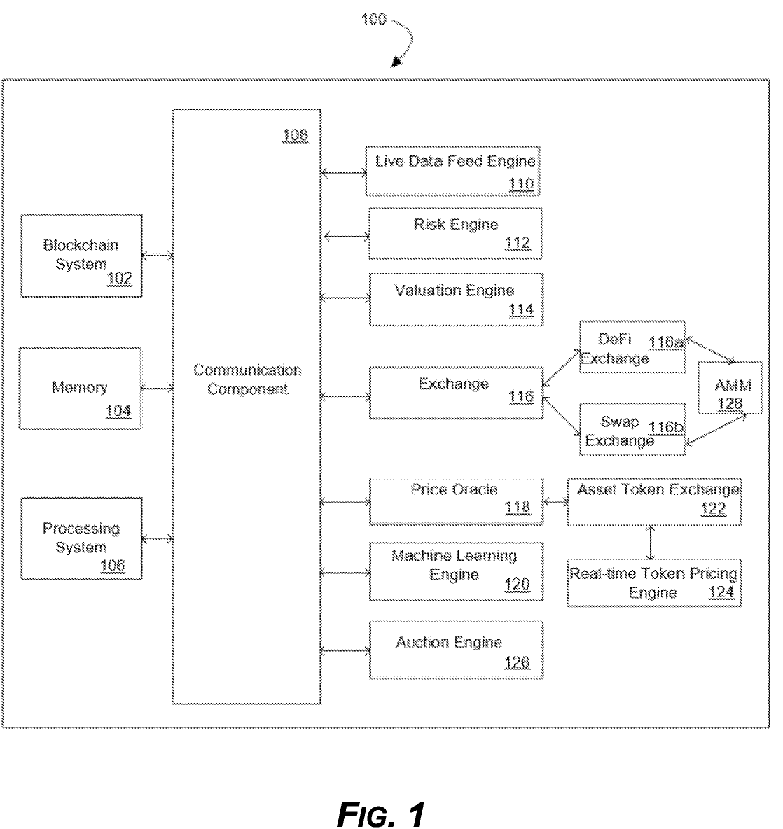

FIG. 1 is a diagram that illustrates a system for the valuation and collateralization of one or more real assets in a Blockchain-based ecosystem in accordance with an exemplary embodiment of the disclosure. Referring to FIG. 1, there is shown a system 100, which includes a Blockchain system 102, a memory 104, a processing system 106, a communication component 108, a live data feed engine 110, a risk engine 112, a valuation engine 114, an exchange 116 (a DeFi exchange 116a and a Swap exchange 116b), a price oracle 118, a machine learning engine 120, an asset token exchange 122, a real-time token pricing engine 124, an auction engine 126 and an Automated Market Maker (AMM) 128.

The Blockchain system 102 is a distributed network of nodes that may comprise suitable logic, circuitry, interfaces and/or code that may be operable to collectively adhere to a consensus algorithm protocol to add and validate new transaction blocks. In an investment setting, the nodes may include, but are not limited to, an investment committee, investors, liquidity providers, project proposers, equity, and loan recipients.

In accordance with an embodiment, the system 100 may be implemented as a valuation, risk, and Decentralized Finance (DeFi) layer that runs on top of a DeFi protocol. The DeFi protocol is designed to handle decentralized investment committees, where the investment committee is formed by high-caliber fiduciaries from anywhere in the world. The decentralized investment committee members can propose themselves as fiduciary service providers and are chosen at random, based on their backgrounds and fit to a project, after which they carry the fiduciary duties of an investment committee member. The DeFi protocol is automated to pick investment committee members randomly from a vast pool of choices if these investment committee members have the requisite skill sets for a particular type of asset. These investment committee members must stake a reasonable amount of real asset tokens to fulfill “bad boy clauses” in the fiduciary capacity.

The memory 104 may comprise suitable logic, interfaces, and/or code, that may be configured to store instructions (for example, computer-readable program code) that can implement various aspects of the present disclosure. The memory 104 is further configured to store computer-executable components.

The processing system 106 is communicatively coupled to the Blockchain system 102 and the memory 104. The processing system 106 may comprise suitable logic, interfaces, and/or code that may be configured to execute the computer-executable components and instructions stored in the memory 104 to implement various functionalities of the system 100 in accordance with various aspects of the present disclosure.

The processing system 106 may be further configured to communicate with various components of the system 100 via the communication component 108.

The communication component 108 may comprise suitable logic, interfaces, and/or code that may be configured to transmit data between modules, engines, databases, memories, and other components of the system 100 for use in performing the functions discussed herein. The communication component 108 may include one or more communication types and utilizes various communication methods for communication within the system 100.

The computer-executable components may include, but are not limited to, the live data feed engine 110, the risk engine 112, the valuation engine 114, the exchange 116 (the DeFi exchange 116a and the Swap exchange 116b), the price oracle 118, the machine learning engine 120, the asset token exchange 122, the real-time token pricing engine 124, the auction engine 126 and the AMM 128.

The live data feed engine 110 may comprise suitable logic, interfaces, and/or code that may be configured to access live data feeds from one or more data sources. The live data feed engine 110 receives consistent data feeds from the one or more data sources aggregated in an Interplanetary File System (IPFS). The live data feeds include a combination of data streams that may include, but are not limited to, price and asset inflation data, Consumer Price Index (CPI) and Non-CPI inflation data, Volatility Index (VIX) data, data relating to real estate leasing activity, data from commercial mortgage-backed securities (CMBS) data providers, data about collateralized debt obligations, sales data, occupancy data from real pages for real estate, hotel occupancy and hotel sales data, market data on the hotel industry worldwide including supply and demand and market share data providing various valuation metrics, data related to Uniform Commercial Code (UCC) filings, Securities and Exchange Commission (SEC) filings, credit ratings, data related to markets, news, research, companies and pricing on various real assets and commodities.

The risk engine 112 may comprise suitable logic, interfaces, and/or code that may be configured to derive risk assessment data based on analyzing the live data feeds.

The valuation engine 114 may comprise suitable logic, interfaces, and/or code that may be configured to decipher the valuation of one or more real assets based on the risk assessment data and the live data feeds. Upon determining that the valuation of a real asset falls below a predefined threshold or a low-water mark, the risk engine 112 is configured to notify an asset owner for providing additional collateral against a loan, wherein the asset owner has collateralized the real asset and taken a loan from the exchange 116.

The valuation engine 114 is also linked to an asset owner who has collateralized the real asset and taken a loan from the exchange 116 and continuously provides the latest valuations on collateralized debt to the price oracle 118, based on one or more machine learning algorithms. The exchange 116 may include, but is not limited to, the DeFi exchange 116a and the Swap exchange 116b.

A machine learning engine 120 may comprise suitable logic, interfaces, and/or code that may be configured to run the one or more machine learning algorithms.

The price oracle 118 may comprise suitable logic, interfaces, and/or code that may be configured to produce real asset prices on the Blockchain system 102.

In accordance with an embodiment, the risk engine 112 is configured to continuously assess risks produced by the live data feeds and updated valuations produced by the valuation engine 114 from the live data feeds.

In accordance with another embodiment, the risk engine 112 interfaces with one or more external entities. The one or more external entities may include, but are not limited to, insurance companies, a decentralized investment committee, custodians who hold liens, UCC filings and documents.

The decentralized investment committee includes people who are experts and those experienced in dealing with different asset types and categories under specific situations or conditions. In addition to expertise and experience, people eligible to be a part of the decentralized investment committee must have high staking of tokens in the system 100. These people can provide proper guidance regarding valuation or risk for an asset type based on one or more real-world events. Some of the asset classes include but are not limited to, Non-fungible tokens (NFT), collectibles, and private funds. The price oracle 118 is fed with a controlled brand of data curated from the decentralized investment committee.

In accordance with an embodiment, if and when there is a sudden dip in the valuation of the real asset and the valuation causes a breach of a certain minimum threshold or low-water mark, the risk engine 112 automatically triggers a ping/feed to the decentralized investment committee.

The system 100 is configured to automatically issue a wake-up to an appropriate expert from the decentralized investment committee based on asset category or type in accordance with a context or event.

In accordance with an exemplary embodiment, the valuation of some simpler commodities and precious metals may be assessed using the live data feeds. However, for assets that are a bit more complex such as a multi-family, a hotel, a solar park, or even a scotch collection, for example, the valuation may have to be initially vetted by the decentralized investment committee.

The DeFi protocol is designed to handle decentralized investment committees that are formed by high-caliber fiduciaries from anywhere in the world. These decentralized investment committee members can propose themselves as fiduciary service providers and are chosen at random, based on their backgrounds and fit to a project, after which they carry the fiduciary duties of an investment committee member. The DeFi protocol is automated to pick investment committee members randomly from a vast pool of choices as long as these investment committee members have the requisite skill sets for that particular type of asset. These investment committee members must stake a reasonable amount of tokens to fulfill their “bad boy clauses” in the fiduciary capacity.

For instance, let us assume an owner/investor or limited partner in a multi-family building in a specific city would like to avail of a two-million-dollar loan against his stake in the building as collateral. The decentralized investment committee may use various data sources for an initial valuation and automated subsequent valuations. For example, the existing cap rates in the city for multi-family assets can be found in multiple databases, and the typical occupancy data for this kind of asset and nearby assets can come from various data providers. Additionally, constant feeds are received from the Volatility Index (VIX) and indices that can warn of a potential calamity, such as, but not limited to, a hurricane or a pandemic. The VIX predicts the occurrence of such an event or indicates its arrival to the valuation engine 114 and the risk engine 112. If there is no shock to the system 100, the data from these various live feeds can be used to predict reasonable valuations along with the projected cash flows and the occupancy of the property. However, these valuations could increase or decrease occasionally, and there can be triggers set for some of these data feeds, such as the VIX or the hurricane index, which can trigger an alarm signal to the decentralized investment committee to wake up, and check if the property needs to be revalued. This may be an automated wake-up call from the risk engine 112 which is constantly monitoring the live feeds on a reliable basis. The valuation engine 114 constantly receives feeds from the risk engine 112, and the live data feeds produce a periodic valuation in a normal course. However, if an unforeseen event occurs, the risk engine 112 would send out a distress signal or a wake-up call to the valuation engine 114 and one or more experts of the decentralized investment committee. As such, the valuation engine 114 is constantly pricing the Sponsor/General Partner tokens, the Investor/Limited Partner tokens, the Debt Tokens issued to the debt provider, and in some cases, even the mezzanine tokens. All these token valuations, in turn, are fed into the price oracle 118.

In accordance with yet another embodiment, the risk engine 112 comprises a real-time risk matrix and analysis tool comprising one or more machine learning algorithms. The one or more machine learning algorithms are adapted to weigh a real asset and produce a risk-formatted readout for the valuation engine 114.

In accordance with yet another embodiment, the risk engine 112 is configured to reset one or more key indicators pertaining to additional collateral put up by an asset owner to abide by a contractual agreement. Upon determining that the additional collateral is not put up by the asset owner within a certain timeframe, the risk engine 112 is configured to automatically produce one or more default tokens indicating that a borrower has defaulted or missed a loan covenant.

Upon determining the asset owner does not put up the additional collateral in case of a valuation change, or the asset owner has defaulted on interest payments or has broken any covenants in a loan agreement with the valuation engine 114, the risk engine 112 is configured to perform additional actions that may include, but are not limited to, producing default tokens, and liquidating original asset tokens.

In accordance with yet another embodiment, the risk engine 112 is configured to transmit a signal to the valuation engine 114 for potential re-evaluation of a real asset and associated tokens of the real asset upon perceiving a new risk or a substantial change in valuation of the real asset.

The valuation engine 114 is configured to receive as input the live data feeds from the live data feed engine and the risk assessment data from the risk engine 112. The valuation engine 114 is configured to perform real-time balancing of the received input, define prices of the one or more real assets as output, and communicate with the DeFi protocol to produce the prices on the Blockchain system 102.

In accordance with an embodiment, the price oracle 118 interfaces with the asset token exchange 122 and is configured to feed asset token valuation to the real-time token pricing engine 124. The price oracle 118 interfaces with the Swap exchange 116b for DeFi components and liquidity pools for one or more collateralized debt obligations and synthetic tokens. The Swap exchange 116b for collateralized debt and liquidity tokens, and the synthetic tokens, in turn, connect with the AMM 128. The AMM 128 allows buyers and sellers to swap cryptocurrencies on the exchange 116 by using pre-funded on-chain liquidity pools.

The real-time token pricing engine 124 is configured to aggregate prices for the one or more real assets if the one or more real assets are collateralized and provide a valuation of each of the one or more real assets. The one or more reals assets are split into a plurality of levels of tokens including, but not limited to, General Partner (GP) token, Liquidity Provider (LP) token, Debt Token, Mezzanine token, and Synthetic token.

In accordance with an embodiment, upon determining that an asset owner does not increase collateral to get a collateral value required above a high-water mark that has been set by the valuation engine 114 within a certain period, the risk engine 112 is configured to produce default tokens automatically and send the default tokens to the auction engine 126 for processing. The auction engine 126 interfaces with an investor portal. As soon as the default tokens are minted by the auction engine 126, the system 100 is configured to notify one or more investors via the investor portal and place the default tokens in an investment gallery for viewing and investments.

Consider a scenario when a Volatility Index (VIX), for instance, which is a measure of a stock market’s expectation of volatility, indicates forthcoming events to the risk engine 112 and the valuation engine 114. If there are no such events, the data from the live data feed engine 110 may be used to predict a reasonable valuation along with the projected cash flows and the occupancy of a property. However, these valuations may increase or decrease occasionally, and triggers may be set for some of these data feeds, such as the volatility or the hurricane index that can trigger an alarm signal to a decentralized investment committee to check if a property needs to be revalued. This may be an automated call signal from the risk engine 112 which is constantly monitoring the live data feeds to the live data feed engine 110 on a reliable basis.

In accordance with an exemplary embodiment, the functionalities of the different components are further described.

The valuation engine 114 constantly obtains feeds from the risk engine 112, and the live data feed engine 110 produces a periodic valuation. However, if an unforeseen event occurs, the risk engine 112 transmits a distress signal or a wake-up call to the decentralized investment committee. As such, the valuation engine 114 is constantly pricing sponsor/GP tokens, the investor/LP tokens, the Debt tokens issued to the debt provider, and sometimes even the Mezzanine tokens. These token valuations are, in turn, fed into the price oracle 118.

The output of the price oracle 118 depends on the quality of the machine learning algorithms executed by the risk engine 112.

In accordance with an embodiment, the risk engine 112 receives live data feeds from a data aggregation engine. The risk engine 112 analyzes and assesses constant risks using the machine learning algorithms executed within the risk engine 112. The risk engine 112 also interfaces with insurance companies to ensure that there is always an insurance coverage for any calamities that may include, but are not limited to, terrorism, floods, and pandemic. These mitigating insurances are secured between the insurance company and the risk engine 112 via the Blockchain system 102—additionally, the risk engine 112 links with custodians who hold the liens, UCC filings, and documents. The risk engine 112 also ensures that the title for the property is always secure with the custodian. The titles may be as simple as for an automobile or machinery, which is titled and held by the custodian, and as complex as GP tokens/units with a fiduciary custodian. If and when there is a sudden dip in valuation, and the valuation causes a breach of a certain minimum threshold or a low-water mark, the risk engine 112 triggers a ping/feed to the valuation engine 114, which in turn is linked to an asset owner who has collateralized such an asset and taken a loan from the DeFi exchange 116a or the Swap exchange 116b. At that point, the asset owner has X amount of time to abide by the smart contract agreement to put up additional collateral until the valuation engine 114 can reset its key indicators with the new collateral added to the original collateral.

The risk engine 112 can finalize the additional collateral needed. Suppose such an additional collateral is not put up within a certain timeframe. In that case, a set of new tokens, called the default tokens, is automatically produced by the risk engine 112, which means the borrower has defaulted or missed a loan covenant. These default tokens are fed to the auction engine 126. Thus, the risk engine 112 constantly assesses the risks produced by the live data feeds from the live data feed engine 110 and the updated valuations produced by the valuation engine 114 and from the live data feeds.

Furthermore, the risk engine 112, which is linked to both the valuation engine 114 and the live data feed engine 110, has the capacity to call for an investment committee meeting in case of high stress. The risk engine 112 also has the capability of asking for additional collateral from the asset owner and to produce default tokens to send to the auction engine 126. In case the asset owner is not putting up additional collateral for a valuation change, or the asset owner has defaulted on his interest payments or has broken any covenants in the loan agreement with the valuation engine 114, the risk engine 112 calls for additional actions of producing default tokens and liquidating the original asset tokens once the lenders are paid off. The new default tokens take over as new owners/controllers of the asset.

In accordance with an exemplary embodiment, the price oracle 118 is constantly receiving feeds from the valuation engine 114, with the latest valuations of all the assets on the DeFi protocol. In addition, for all the collateralized debt or collateralized debt obligations that are active on the DeFi protocol, the price oracle 118 is constantly receiving feeds from the valuation engine 114 with the latest valuations on collateralized debt based on the algorithms that are running in the background, with the live data feed engine 110, the risk engine 112, the price oracle 118 and the valuation engine 114 interacting with each other continuously. Essentially, the live data feed engine 110, the valuation engine 114, and the risk engine 112 constantly provide the latest pricing feeds to the pricing oracle 118. These feeds may also be fed via Application Programming Interfaces (APIs) to other protocols and exchanges for a fee. These asset token valuation feeds are simultaneously fed from the price oracle 118 to the real-time token pricing engine 124. For instance, the various types of tokens and Non-Fungible Tokens (NFTs) are constantly priced and valued by the price oracle 118.

The price oracle 118 also interfaces with the two types of exchanges, namely the asset token exchange 122 for asset tokens, which in turn interfaces with all the investors, and the Swap exchange 116b for DeFi components of the system 100, and liquidity pools for various collateralized debt obligations and synthetic tokens.

The Swap exchange 116b for collateralized debt and liquidity tokens, and synthetic tokens, in turn, connects with the AMM 128. Investors are constantly providing capital to the asset token exchange 122 and the Swap exchange 116b; the investors are continually communicating through the investor portal with the asset token exchange 122, the Swap exchange 116b, and the AMM 128. Further, the DeFi protocol handles lending against real assets and real assets-based tokens. In addition, the DeFi protocol can also handle synthetic tokens if needed. Thus, the price oracle 118 and the exchanges are more focused on real-world tokens.

The auction engine 126 is connected to and constantly communicates with the risk engine 112. As soon as the risk engine 112 perceives a new risk, the risk engine 112 transmits a signal to the valuation engine 114 for potential re-evaluation of the asset and all its various associated tokens. The valuation engine 114 determines, based on the live data feeds and the data from the risk engine 112, that the valuation has substantially changed, and the decentralized investment committee for that asset is called upon on the occurrence of such serious events to revalue the asset. If the asset owner does not increase the collateral to get the collateral value required above the high-water mark set by the valuation engine 114 within a certain period, the risk engine 112 automatically produces default tokens, which are provided to the auction engine 126 for further processing.

The auction engine 126 interfaces with the investor portal. As soon as the default tokens are minted by the auction engine 126, all the investors are notified via the investor portal. The new default tokens are placed in the investment gallery for viewing and are open to investments. The new investment or specialized new investment of default tokens are placed in the investor portal and can also be placed in the various DeFi exchanges, including third-party exchanges and proprietary exchanges, such that new specialized investors may buy the default tokens. However, the condition of the default token is that the original liquidity provider who has provided liquidity against the collateral be paid first, and after the liquidity providers are satisfied, the remaining equity in the property and the ownership of the property are passed over to the default token holders.

The custodians holding the titles or the liens, or the UCC filings are authorized immediately by the risk engine 112 to transfer the asset ownership to the default token holders. Complex mechanisms are implemented for the governance of these tokens, including the governance of the asset and how the asset is put back on the DeFi protocol, with its new owners controlling actions about the property. After they cross a certain stabilization period, these default tokens are converted to new GP tokens. The new default token holders become general partners in the property or limited partners where applicable.

The real-time token pricing engine 124 constantly communicates with the price oracle 118 and continuously obtains feeds from the price oracle 118 to initially price or reprice the tokens. The real-time token pricing engine 124 aggregates the prices for various assets if they are collateralized or provides a valuation of individual assets.

In accordance with an embodiment, the real-time token pricing engine 124 is configured to automate a capitalization (cap) table, which may contain from five ownership entries up to even a million ownership entries for a single asset, for instance. A financial waterfall model of an asset and the cap table are automated. The calculations, waterfalls, and dividend payments are all automated in the real-time token pricing engine 124.

The assets onboarded to the DeFi protocol may have several tokens associated with a single asset. For example, a project owner or a proposer may have GP tokens correlated with the ownership risk of taking or sponsoring the project. A lender lends debt tokens to the project. There may be multiple levels of debt: senior debt, junior debt, or mezzanine debt. These various debt levels may have separate tokens in the waterfall and the cap table. Additionally, synthetic tokens may be derived from assets to trade on the Swap exchange 116b.

In accordance with an embodiment, the Blockchain system 102 enables automation of the cap table and the waterfall model along with the ownership of the assets and respective dividend payments, such that there is no dispute in any of these calculations or ownership percentages throughout the lifecycle of these assets. These processes are pre-agreed and automated for the lifecycle of the project.

In accordance with an exemplary embodiment, the asset token platform, or the Swap exchange 116b, facilitates key activities pertaining to transactions based on real estate investments and various other asset classes. For instance, after investors have subscribed to completed Security Token Offerings (STOs), they are, in turn, issued Asset Tokens (ATs), which form a fractionalized ownership stake in the respective asset that provide the same rights and rewards to such a real estate ownership in the traditional sense and possess the benefits of liquidity, transparency, and accessibility. The Swap exchange 116b also processes synthetic tokens and other associated real asset tokens as defined within the capacity of the price oracle 118. The ATs are tradable on the secondary market defined within the Swap exchange 116b.

The AMMs allow buyers and sellers to swap cryptocurrencies on the exchange 116, by using pre-funded on-chain liquidity pools. This provides liquidity providers to earn passive income via trading fees based on the percentage of their contribution to the pool. The AMMs utilize algorithmic smart contracts on-chain to replicate certain types of price actions in the traditional space for the purpose of DeFi. The different types of AMMs may include, but are not limited to, Constant Sum Market Maker (CSMM), Constant Mean Market Maker (CMMM), and other hybrids, all with the intent of overcoming inhibitors to usage and allowing for robust capital efficiency. Specifically, the Constant Function AMM (CFMM) is of relevance for the DeFi protocol. These AMMs are based on a constant function, where the combined asset liquidity on both sides of a liquidity pool remains unchanged and are therefore held constant through algorithmic processes. The most popular evolution of the CFMM is the Constant Product Market Maker (CPMM). Essentially, CPMMs are based on the function x*y=k, which establishes the prices for two tokens (x and y) on either side of the liquidity pool, according to their available quantities in each pool. When the supply of token X increases, the token supply of Y must decrease, and vice-versa, to maintain the constant product K. When plotted, the result is a hyperbola where liquidity is always available but at increasingly higher prices approach infinity at both ends.

With constant liquidity on either side, slippage is significantly reduced, and price efficiency can be sought even with high demand or supply. Volatility is also extensively hedged against since it would require significant capital of swaps to disrupt the AMM pool on either end. This is considering that a substantial sum of capital liquidity is deposited, which is easily achieved due to the nature of the asset token platform sales (high initial liquidity from sales).

Adapting the CPMM to the asset token platform is a key aspect of the system 100. The nature of the STOs conducted on the platform results in specific requirements on the token transaction and flow. These are not the same requirements placed on external tokens, that do not trade in security-based instruments, for instance. Thus, the CPMM method trading/swaps are provided within the asset token platform itself, providing the security and regulated environment of a real estate focused platform with the merits of a high liquidity and a transparent trading system.

The AMM 128, in accordance with the present disclosure, is a decentralized format introduced by the asset token platform into its core trading engine for the secondary market. The CPMM concept (x*y=k) is further evolved for the DeFi protocol by merging it with the Know Your Customer (KYC) and asset ownership functionalities which are critical in real estate. Through the CPMM model, the DeFi protocol achieves liquidity upon unlocking the STO tokens. Due to the asset backed nature of the tokens combined with high liquidity set aside in the initial pools, the DeFi protocol effectively hedges against the volatility that is sometimes seen in existing AMMs. Furthermore, to reward participation in liquidity pools, AMMs are provided proprietary LP tokens corresponding to the respective STO pool they are supporting.

The investor portal has various functionalities that may include, but are not limited to, KYC, anti-money laundering (AML) compliance, Docusign, reporting, portfolio management, and investor communication. The investor portal interfaces with the asset token exchange 122, the Swap exchange 116b for synthetic tokens, and the AMM 128. Depending on what kind of tokens the investors purchase and are interested in, the investors are allocated LP tokens, Debt tokens, Mezzanine tokens, or default tokens from the auction engine 126. The GP tokens, LP Tokens, Debt tokens, Mezzanine tokens, and synthetic tokens are usually issued by the DeFi protocol in accordance with the present disclosure.

In accordance with another embodiment, a project proposer portal links the system 100 and the interface to the DeFi protocol of the Blockchain system 102. For instance, a project proposer may propose assets to the DeFi protocol via the project proposer portal. These assets are then proposed to the valuation engine 114, which in turn interfaces with the decentralized investment committee to have an initial look at the asset and forwards this proposal to the DeFi protocol stake holders once it is completed and valuable enough to be reviewed by the community. Based on the project that is proposed and once approved by the valuation engine 114, each token type, the GP token, LP token, Debt token, and Mezzanine token, where applicable, are provided a certain valuation, and the cap table is designed based on the pricing and valuation that is produced by the price oracle 118. The tokens are minted by the real-time token pricing engine 124. The real-time token pricing engine 124 then puts up this asset for funding to either the Swap exchange 116b or the asset token exchange 122, or the AMMs 128, from which the investors can provide funding for any of these tokens in a compliant manner through the investor portal.

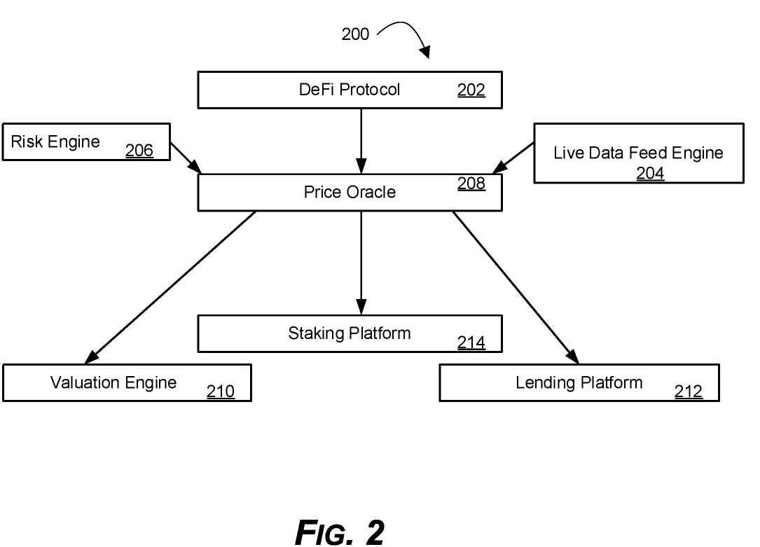

FIG. 2 is a diagram that illustrates a price oracle infrastructure in accordance with an exemplary embodiment of the disclosure. Referring to FIG. 2, there is shown a price oracle infrastructure 200, which includes a DeFi protocol 202, a live data feed engine 204, a risk engine 206, a price oracle 208, a valuation engine 210, a lending platform 212 and a staking platform 214.

The DeFi protocol 202 is built on (but not restricted to) Ethereum using the COSMOS Software Development Kit (SDK) for linkage and exists in a state of being interoperable with the other Blockchains and protocol platforms, enabling the live data feed engine 204 and the risk engine 206 to power a myriad of collateralization, lending and borrowing markets, in a permission-less manner.

The price oracle 208 pushes data to the valuation engine 210 for use in the DeFi protocol ecosystem for collateralization, for example. The price oracle 208 can also concurrently power other platforms such as, but not limited to, the lending platform 212 and the staking platform 214 in the DeFi space.

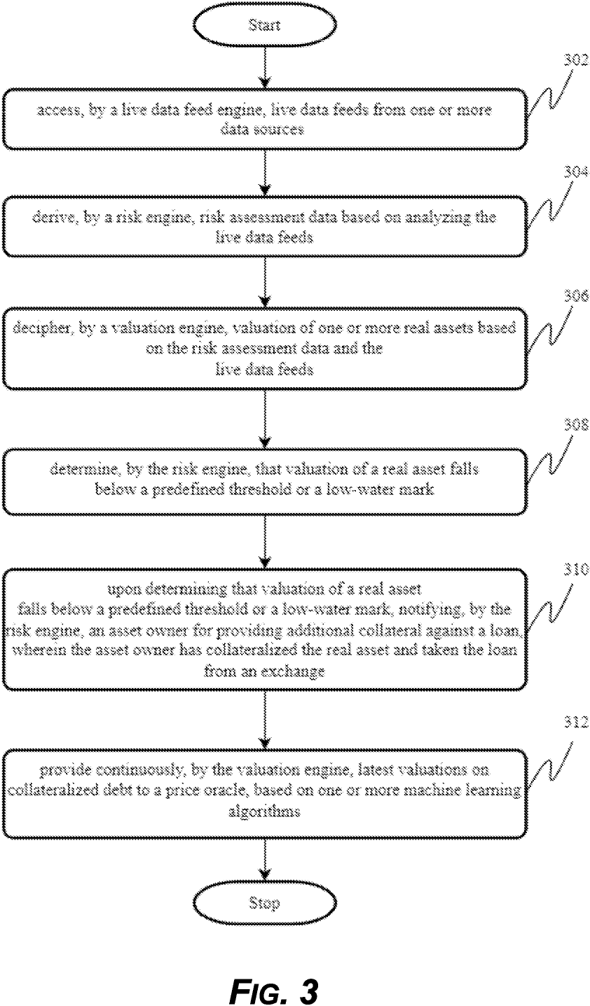

FIG. 3 is a diagram that illustrates a flowchart of a method for valuation and collateralization of one or more real assets in a Blockchain-based ecosystem in accordance with an exemplary embodiment of the disclosure. Referring to FIG. 3, there is shown a flowchart of a method 300 for the valuation and collateralization of one or more real assets in a Blockchain-based ecosystem.

At 302, access, by a live data feed engine, live data feeds from one or more data sources. The live data feed engine 110 is configured to access live data feeds from one or more data sources.

At 304, derive, by a risk engine, risk assessment data based on analyzing the live data feeds. The risk engine 112 is configured to derive risk assessment data based on analyzing the live data feeds.

At 306, decipher, by a valuation engine, the valuation of one or more real assets based on the risk assessment data and the live data feeds. The valuation engine 114 is configured to decipher the valuation of one or more real assets based on the risk assessment data and the live data feeds.

At 308, determine, by the risk engine, that the valuation of a real asset falls below a predefined threshold or a low-water mark. The risk engine 112 is configured to ensure that valuation of a real asset falls below a predefined threshold or a low-water mark.

At 310, upon determining that the valuation of a real asset falls below a predefined threshold or a low-water mark, notify, by the risk engine, an asset owner for providing additional collateral against a loan, wherein the asset owner has collateralized the real asset and taken the loan from an exchange. The risk engine 112 is configured to notify the asset owner for providing additional collateral against a loan upon determining that the valuation of a real asset falls below a predefined threshold or a low-water mark, wherein the asset owner has collateralized the real asset and taken the loan from the exchange 116.

At 312, provide continuously, by the valuation engine, the latest valuations on collateralized debt to a price oracle, based on one or more machine learning algorithms. The valuation engine 114 is configured to continuously provide the latest valuations on collateralized debt to the price oracle 118, based on the one or more machine learning algorithms.

The present disclosure is advantageous in that it uses a Blockchain system with governance functions to fully decentralize the platform and provide a sustainable token economy that powers the DeFi protocol with incentivization and fees. The price oracle is the heart of the protocol, bridging real-world assets and the Blockchain system. It is a critical function that is the missing link that transcends synthetic assets to tokenizing and owning real-world underlying assets. The price oracle actively tracks and values any asset.

The system of the present disclosure is interoperable and allows DeFi protocols the ability to tap on it for their respective use cases that may include, but are not limited to, currency, collateralization, decentralized exchanges (DEXs), and lending/borrowing.

The system works through a decentralized oracle network built directly on top of the DeFi protocol infrastructure. The system is permissionlessly available to other protocols at a fee, payable in tokens. The strong usage expected from the ability to collateralize real-world assets on to DeFi protocols consequently leads to strong demand for the tokens. The protocol aggregates DeFi demand through the price oracle. Users who collateralize using the price oracle system on another DeFi protocol can also use the same collateral across any other DeFi protocol ecosystem. This forms a useful dual track of collateralization.

Those skilled in the art will realize that the above-recognized advantages and other advantages described herein are merely exemplary and are not meant to be a complete rendering of all the advantages of the various embodiments of the present disclosure.

The present disclosure may be realized in hardware or a combination of hardware and software. The present disclosure may be realized in a centralized fashion, in at least one computer system, or in a distributed fashion, where different elements may be spread across several interconnected computer systems. A computer system or other apparatus/devices adapted to carry out the methods described herein may be suited. A combination of hardware and software may be a general-purpose computer system with a computer program that, when loaded and executed on the computer system, may control the computer system such that it carries out the methods described herein. The present disclosure may be realized in hardware comprising a portion of an integrated circuit that performs other functions. The present disclosure may also be realized as firmware which forms part of the media rendering device.

The present disclosure may also be embedded in a computer program product, which includes all the features that enable the implementation of the methods described herein and which, when loaded and executed on a computer system, may be configured to carry out these methods. A computer program, in the present context, means any expression, in any language, code, or notation, of a set of instructions intended to cause a system with information processing capability to perform a particular function either directly or after either or both of the following: a) conversion to another language, code, or notation; b) reproduction in a different material form.

In the foregoing specification, specific embodiments of the present disclosure have been described. However, one of the ordinary skills in the art appreciates that various modifications and changes can be made without departing from the scope of the present disclosure. Accordingly, the specification and figures are to be regarded in an illustrative rather than a restrictive sense, and all such modifications are intended to be included within the scope of the appended claims.

What is claimed is:

1. A system, comprising:
a blockchain system;
a memory configured to store computer-executable components;
a processing system communicatively coupled to the blockchain system and the memory, the processing system configured to execute the computer-executable components, the computer-executable components comprising:
a live data feed engine configured to access live data feeds from one or more data sources;
a risk engine configured to derive risk assessment data based on analyzing the live data feeds;
a valuation engine configured to decipher valuation of one or more real assets based on the risk assessment data and the live data feeds,
wherein, upon determining that valuation of a real asset falls below a predefined threshold or a low-water mark, the risk engine is configured to notify an asset owner for providing additional collateral against a loan, wherein the asset owner has collateralized the real asset and taken the loan from an exchange; and
wherein the valuation engine continuously provides latest valuations on collateralized debt to a price oracle, based on one or more machine learning algorithms.

2. The system of claim 1, wherein the live data feed engine receives consistent data feeds from the one or more data sources aggregated in an Interplanetary File System (IPFS).

3. The system of claim 1, wherein the live data feeds comprise a combination of data streams selected from a group consisting of: price and asset inflation data, Consumer Price Index (CPI) and Non-CPI inflation data, Volatility Index (VIX) data, data relating to real estate leasing activity, data from commercial mortgage-backed securities (CMBS) data providers, data about collateralized debt obligations, sales data, occupancy data from real pages for real estate, hotel occupancy and hotel sales data, market data on the hotel industry worldwide including supply and demand and market share data providing various valuation metrics, data related to Uniform Commercial Code (UCC) filings, Securities and Exchange Commission (SEC) filings, credit ratings, data related to markets, news, research, companies and pricing on various real assets and commodities.

4. The system of claim 1, wherein the risk engine is configured to continuously assess risks that are produced by the live data feeds, and updated valuations that are produced by the valuation engine from the live data feeds.

5. The system of claim 1, wherein the risk engine interfaces with one or more external entities, wherein the one or more external entities comprise at least one of insurance companies, a decentralized investment committee, custodians who hold liens, UCC filings and documents.

6. The system of claim 1, wherein the risk engine comprises a real-time risk matrix and analysis tool comprising one or more machine learning algorithms, wherein the one or more machine algorithms are adapted to weigh a real asset and produce a risk-formatted readout for the valuation engine.

7. The system of claim 1, wherein the risk engine is further configured to reset one or more key indicators pertaining to additional collateral put up by an asset owner to abide by a contractual agreement, wherein upon determining that the additional collateral is not put up by the asset owner within a certain timeframe, the risk engine is configured to automatically produce one or more default tokens indicating that a borrower has defaulted or missed a loan covenant.

8. The system of claim 7, wherein, upon determining the asset owner does not put up the additional collateral in case of a valuation change, or the asset owner has defaulted on interest payments or has broken any covenants in a loan agreement with the valuation engine, the risk engine is configured to perform additional actions comprising producing default tokens and liquidating original asset tokens.

9. The system of claim 1, wherein the risk engine is configured to transmit a signal to the valuation engine for potential re-evaluation of a real asset and associated tokens of the real asset, upon perceiving a new risk or a substantial change in valuation of the real asset.

10. The system of claim 1, wherein the exchange is at least one of a Decentralized Finance (DeFi) exchange and a Swap exchange.

11. The system of claim 1, wherein the valuation engine is configured to receive as input the live data feeds from the live data feed engine and the risk assessment data from the risk engine, wherein the valuation engine is configured to perform real-time balancing of the received input, define prices of the one or more real assets as output and communicate with a DeFi protocol to produce the prices on the blockchain system.

12. The system of claim 1, wherein the price oracle interfaces with an asset token exchange, wherein the price oracle is configured to feed asset token valuation to a real-time token pricing engine.

13. The system of claim 12, wherein the real-time token pricing engine is configured to aggregate prices for the one or more real assets if the one or more real assets are collateralized, and provide valuation of each of the one or more real assets, wherein the one or more reals assets are split into a plurality of levels of tokens comprising General Partner (GP) token, Liquidity Provider (LP) token, Debt Token, Mezzanine token and Synthetic token.

14. The system of claim 1, wherein the price oracle interfaces with a Swap exchange for DeFi components and liquidity pools for one or more collateralized debt obligations and synthetic tokens, wherein the Swap exchange for collateralized debt and liquidity tokens, and the synthetic tokens in turn connect with an automated market maker (AMM).

15. The system of claim 14, wherein the AMM allows buyers and sellers to swap cryptocurrencies on an exchange, by using pre-funded on-chain liquidity pools.

16. The system of claim 1, wherein, upon determining that an asset owner does not increase collateral to get a collateral value required above a high-water mark that has been set by the valuation engine, within a certain period, the risk engine is configured to automatically produce default tokens and send the default tokens to an auction engine for processing.

17. The system of claim 16, wherein the auction engine interfaces with an investor portal, wherein, as soon as the default tokens are minted by the auction engine, the system is configured to notify one or more investors via the investor portal and place the default tokens in an investment gallery for viewing and investments.

18. A computer-implemented method in a Blockchain-based ecosystem, comprising:
accessing, by a live data feed engine, live data feeds from one or more data sources;
deriving, by a risk engine, risk assessment data based on analyzing the live data feeds;
deciphering, by a valuation engine, valuation of one or more real assets based on the risk assessment data and the live data feeds;
determining, by the risk engine, that valuation of a real asset falls below a predefined threshold or a low-water mark;
upon determining that valuation of a real asset falls below a predefined threshold or a low-water mark, notifying, by the risk engine, an asset owner for providing additional collateral against a loan, wherein the asset owner has collateralized the real asset and taken the loan from an exchange; and
providing continuously, by the valuation engine, latest valuations on collateralized debt to a price oracle, based on one or more machine learning algorithms.

19. A non-transitory machine-readable storage medium comprising machine-readable instructions for causing a processor to execute the method of claim 18.
